(19) United States
(12) Patent Application Publication
(10) Pub. No.: US 2012/0011436 A1
(43) Pub. Date: Jan. 12, 2012

(54) Devices and Methods of a User Interface for a Small Display Screen

(75) Inventors: Nicholas A. Jinkinson, Reading (GB); Sheila A. Foley, Naperville, IL (US); Ignacio Germade, Oxford (GB); Ryan A. Powell, Seattle, WA (US); Nicholas Woodley, London (GB)

(73) Assignee: Motorola, Inc., Schaumburg, IL (US)

(21) Appl. No.: 12/610,764

(22) Filed: Nov. 2, 2009

(51) Int. Cl. G06F 3/01; G06F 3/033

(52) U.S. Cl. 715/702

(57) ABSTRACT

Disclosed are devices and methods of user interfaces of devices. Such a device includes a display and has at least two keys configured for tactile awareness adjacent thereto. Such keys also can be configured to receive input signals of two types. Two types of input signals can be touch input signals and press input signals. Tactile awareness of a key provides that a user can know when the user has touched the key. Initial information displayed upon the screen can be scrolled when the device receives an input signal of a first key within a predetermined time of receiving an input signal of a second key. A disclosed method further can include, after scrolling the initial information, new information is displayed on the display so that one or more distinct portions of the new information is aligned with one or more of the keys.

### FIELD

Disclosed are devices and method of a user interface for a small display screen, such as a CLI display, and more particularly a small display screen having at least two keys configured for tactile awareness adjacent thereto to provide user input.

### BACKGROUND

Electronic devices, including mobile communication devices typically include displays to indicate information to their users. Many different form factors for mobile communication devices include what are known as CLI displays. CLI refers to a caller line identifier. CLI displays are often ancillary displays to one or more main displays of an electronic device. For a mobile communication device having a clam shell form factor, a CLI display is located on the housing's exterior. When the clam shell form factor mobile communication device is opened, a main display is revealed.

Main display screens of electronic devices typically act as user interfaces for the devices. A main display screen may be, for example, a touch screen so that the device may receive user commands via a touch of the screen. On the other hand, a main display screen may provide soft key indicators, so that certain fixed keys, for example, on a keypad, change their functionality based on the indication of the then displayed user interface.

A CLI display is often utilized to provide abbreviated information, compared to that of a main display of an electronic device, such as a mobile communication device. For example, when a call, text message or pushed message is received, the CLI display may provide caller identification. To access further information about the incoming communication, a user typically must access the main display. While a CLI may be “on” while a mobile communication device is in standby mode to provide information such as the date and time, a CLI display typically is smaller than a main display so that it will utilize less power than a main display.

### BRIEF DESCRIPTION OF THE DRAWINGS

FIG. 1 depicts an embodiment of an electronic device 102 that may be a communication device;

FIGS. 2, 3 and 4 depict an embodiment of a device including the scrolling motion of initial information as it moves to the left across the display screen of the device;

FIG. 5 depicts an embodiment of a device including the scrolling motion of initial information as it moves to the left across the display screen of the device;

FIG. 6 depicts an embodiment of a device including new information displayed on the display screen;

FIG. 7 depicts an embodiment of a device including displaying new information on the display so that one or more distinct portions of the new information is aligned one or more of the keys;

FIG. 8 depicts an embodiment of a device including displaying different information on the display;

FIG. 9 depicts an embodiment of an electronic device that may be a mobile communication device in an open position; and

FIG. 10 is a flow chart illustrating an embodiment of the disclosed method.

### DETAILED DESCRIPTION

On a main display, a user can utilize a user interface, for example, to access information about an incoming communication and other applications. It is common for both the general user interface and specific applications to feature a number of interface levels or layers which allow the user to reach different areas, often containing extended information, extended features or extended functionality that may not be practically viewable on a ‘home screen’ or ‘main menu’ screen. For example, information can include the date, time, telephone number, and/or the name of caller, the number of times calls have been received from a caller, the number of messages in voicemail from a caller, the number of text messages receive from a caller, to name a few types of information. On a main display, a user can drill down through layers of a user interface to access information below the surface of the user interface.

It would be beneficial were the small display such as a CLI display capable of providing a user the ability to drill down through layers of a user interface to access information similar to that of the main display. Since a main display utilizes more power than a display such as a CLI display due to its size, the power draw be less for accessing such information on a smaller display such as a CLI display. Moreover, a main display may be inconvenient for a user to access at certain times, particularly in a folding form factor device. The act by the user of accessing the main display may not be necessary when the same type of information may be displayed on a smaller display such as CLI display.

Disclosed are devices and methods of user interfaces of devices. Such a device includes a display and has at least two keys configured for tactile awareness. Such keys also can be configured to receive input signals of two types. Two types of input signals can be touch input signals and press input signals. Tactile awareness of a key provides that a user can know when the user has touched the key. Such a key may be concave, patterned, and/or textured for tactile awareness of the user upon touch.

A disclosed method includes displaying initial information on the display. Initial information displayed upon the screen can be scrolled when the device receives an input signal of a first key within a predetermined time of receiving an input signal of a second key. Such would be provided by touch signals of two adjacent keys in sequence. A disclosed method further can include, after scrolling the initial information, displaying new information on the display so that one or more distinct portions of the new information is aligned with one or more of the keys. The keys can therefore act as soft keys for the then displayed user interface. Upon another touch type of touch signal of a key, for example, a press, a user can drill down through one or more layers of a user interface. In this way, a small display, such as a CLI display, can provide a substantial user interface.

In the case where the disclosed devices and methods of user interfaces of device are utilized on a CLI display of a mobile communication device, a user can access layers of the user interface without accessing the main display, potentially saving time for a user and power of the device. In any case, the disclosed devices and methods of user interfaces of devices provides a substantial user interface for small screens.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

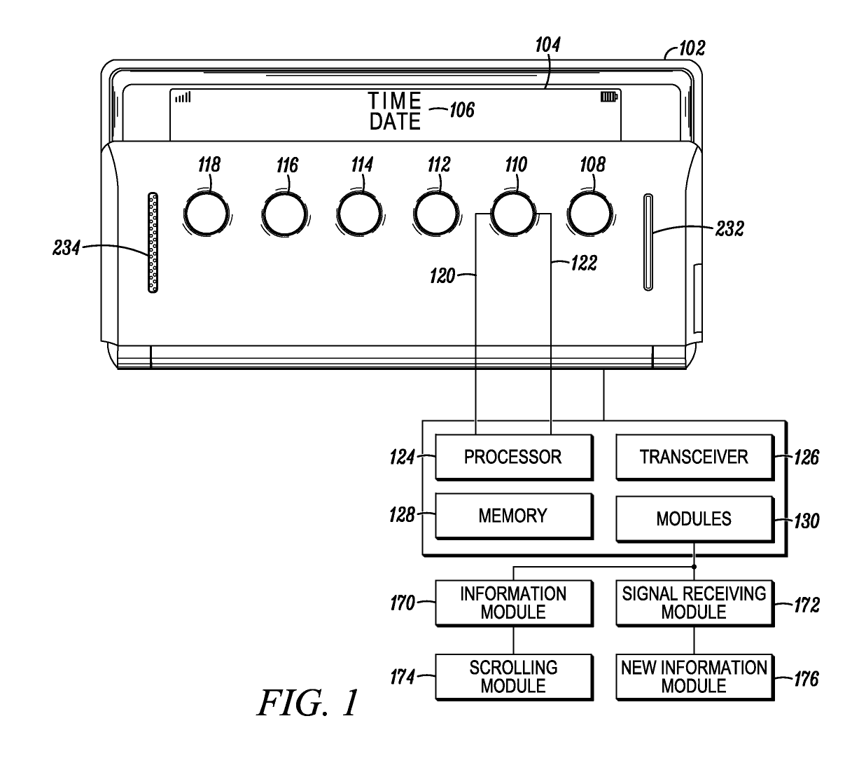

FIG. 1 depicts an embodiment of an electronic device 102 that may be a communication device. The electronic device 102 may be any type of electronic device, portable or wired, and this discussion is not limited to that of a mobile communication device. That being said, the depicted device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The device 102 may have any configuration. The depicted screen 104 may utilize any dimensions, and may be of any size relative to the device 102. In the depicted embodiment may be a folding device, wherein the housing exterior of the device includes a CLI display. A main display may be revealed when the device is opened. The main display of the device may be hidden when the top housing of the device is folded over the bottom housing of the device. It is understood that while the discussion refers to the display 104 as a CLI display, it may be a main display of the device, or one of many main displays of the device.

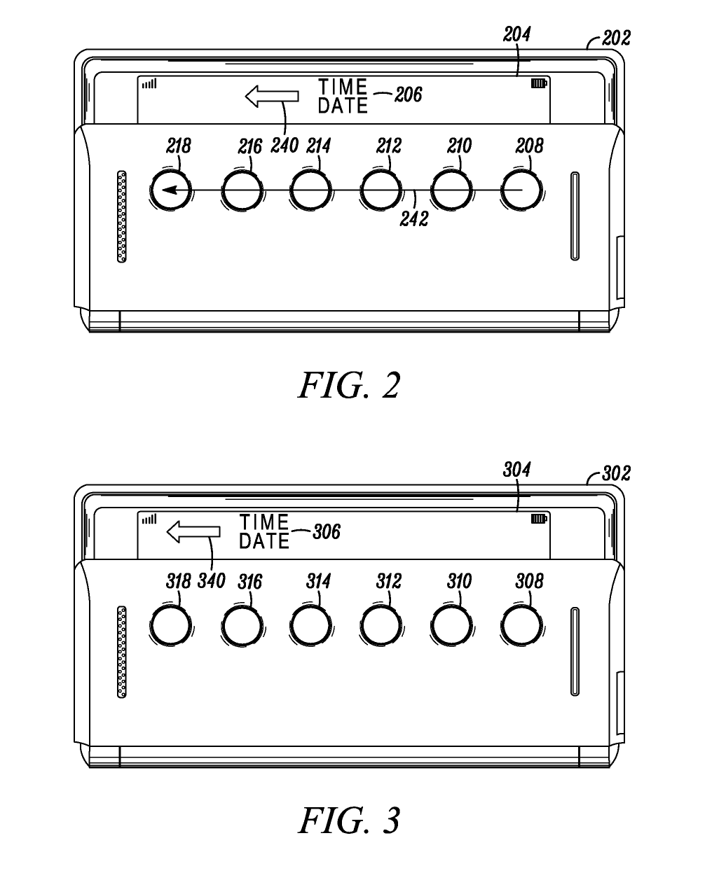

The time and date 106 is displayed on the display 104. Such information is an example of information that may be displayed as initial information. As mentioned above, initial information displayed upon the screen can be scrolled when receiving an input signal of a first key within a predetermined time of receiving an input signal of a second key. Briefly referring to FIGS. 2-4 and FIG. 5, two different types of information are shown as initial information displayed upon the screen that can be scrolled. It is understood that the initial information can be any type of information. FIGS. 2-4 are intended to depict action of the initial information of FIG. 1 moving across the screen in response to a swiping gestural motion by the user. The motion results in an input signal of a first key within a predetermined time of receiving an input signal of a second key.

There are at least two keys 108 and 110 adjacent the display 104 in any suitable configuration. Any number of additional keys, 112, 114, 116 and 118 may be utilized. As mentioned above, at least two keys 108 and 110 are configured for tactile awareness and are also configured to receive input signals of two types. Two types of input signals can be, for example, touch input signals and press input signals.

Two circuit elements 120 and 122 coupled to key 110 are depicted in communication with the processor 124. Two circuit elements may be required to differentiate between a light touch and a press. Only one key 110 is shown as including the circuit elements 120 and 122 for simplicity of the drawing. However, at least two keys 108 and 110 include at least two different types of input sensors. For example, each key may include at least two of capacitive, resistive, infrared or mechanical sensors. In this way, each key can detect two types of touch input. It is understood that the two keys 108 and 110 may be positioned in any suitable arrangement with respect to the display 104 and that their position in FIG. 1 is a matter of convenience and in no way is meant to limit the configuration of a device including the disclosed user interface methods.

The depicted mobile communication device 102 may include a transceiver 126, memory 128 and modules 130. The modules can include for example, an information module 170 configure to provide instructions for displaying information on the display, a scrolling module 174 configured to provide instructions for scrolling the information being displayed on the display when an input signal of a first key is received within a predetermined time to when an input signal of a second key is received, and a new information module 176 configured to provide instructions for displaying new information so that one or more distinct portions of the new information is aligned one or more the keys. A signal receiving module 172 may determine, for example, if a gestural touch signal is received, and/or a press signal is received, and/or if any other type of input signal is received.

The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

As mentioned, a main display may be inconvenient for a user to access at certain times, particularly in a folding form factor device (see FIG. 9). The act by the user of accessing the main display may not be necessary when the same type of information may be displayed on a smaller display such as CLI display. As will described in more detail below, the general user interface and specific applications that feature a number of interface levels or layers which allow the user to reach different areas, often containing extended information, extended features or extended functionality may be accessed on the small screen 104 in conjunction with at least two keys, for example, keys 108 and 110. For example, if a user were to wish to make a call to a communication address stored in device telephone book, a user could access that information on the small display 104 in accordance with the methods and devices described below. Thus, a user could place a call, and use the device 102 like a candy bar form factor mobile communication device positioned proximal the head of the user by utilizing the speaker 232 and the microphone 234 without needing to reveal the main display of the folding form factor device to access the telephone book.

FIGS. 2, 3 and 4 depict an embodiment of a device including the scrolling motion 240 of initial information 206 as it moves to the left across the display screen 204 of the device 202. It is understood that the direction and other dimensional characteristics of the scrolling motion of the initial information is dependent upon the implementation of the disclosed devices and methods of user interfaces of devices and is not limited by the depiction provided in the figures associated with this discussion.

As mentioned above, two keys touched in a gestural manner, such as by a swiping action by a user, can provide an input signal of a first key 208 within a predetermined time of receiving an input signal of a second key 210. The arrow 242 is intended to depict that touch across two keys is in the direction of the scrolling motion 240 of the initial information 206. It is understood that the number of keys touched needs only to be two keys. Motion across two keys for example, key 208 and key 210 within a predetermined time, accordingly, provides a scrolling motion of the initial information 206. As the keys are touched, a form of annunciation may indicate that they have been touched. For example, the keys may illuminate. Moreover, an audio sound may provide an indication the keys have been touched.

It should be noted that the initial information can be any type of initial information. Briefly turning to FIG. 5, initial information of another type is depicted. For example, FIG. 5 depicts initial information where one or more distinct portions of the initial information is aligned with one or more keys.

FIG. 3 depicts that based on the input signal of the first key 208 within a predetermined time of receiving an input signal of a second key 210, that the initial information 306 has scrolled a distance across the display 304. The time it takes for the initial information 306 to move across the display is provided by the implementation of the disclosed methods.

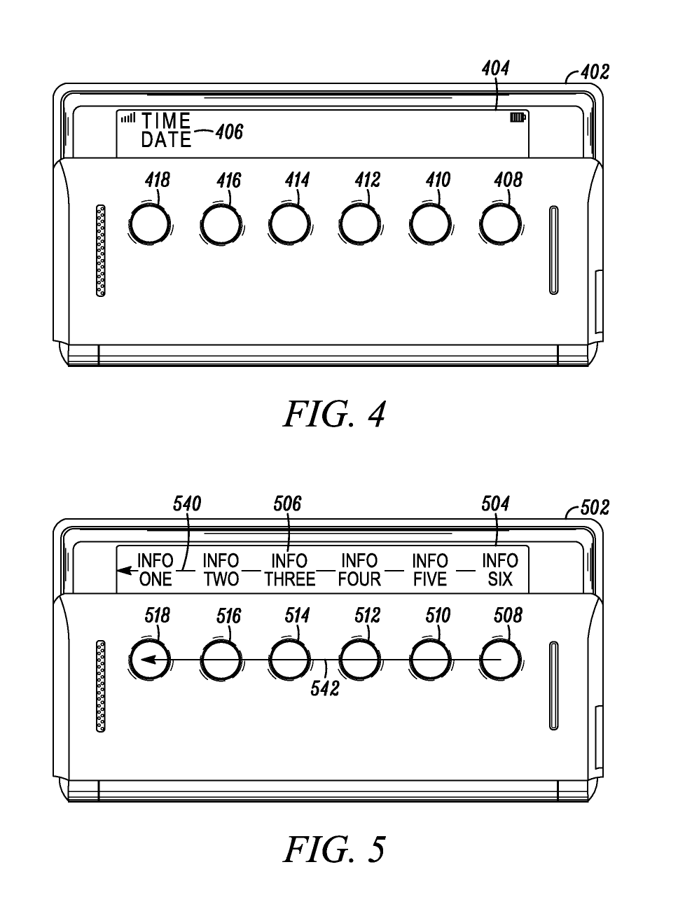

FIG. 4 depicts that based on the input signal of the first key 208 within a predetermined time of receiving an input signal of a second key 210, that the initial information 406 has scrolled a distance across the display 404. New information may appear on the display screen 404 while the initial information 406 is on the screen, or after the initial information 406 leaves the screen.

As discussed above, at least two keys 408 and 410 include at least two different types of input sensors. One key 110 (see FIG. 1) is depicted as having circuit elements 120 and 122 in communication with a processor 124. For example, each key may include at least two of capacitive, resistive, infrared or mechanical sensors. In this way, each key can detect two types of touch input. For a user to know that the user has touched two keys, at least two keys 308 and 310 are configured to provide tactile awareness. Tactile awareness provides that a user can know when the user has touched the key. Such a key may be concave, patterned, and/or textured for tactile awareness of the user upon touch. Additionally, when a key is pressed, the user may receive tactile feedback so that it is clear to the user that a press signal has been initiated.

FIG. 5 depicts an embodiment of a device including the scrolling motion 540 of initial information 506 including “info one, info two, info three, info four, info five” and “info six” as it moves to the left across the display screen 504 of the device 502. FIG. 5 depicts initial information where one or more distinct portions of the initial information “info one, info two, info three, info four, info five” and “info six” is aligned one or more of the keys 508, 510, 512, 514, 516 and 518. The information shown in FIG. 5 can be, for example, categories of information. In this way, the keys can act as soft keys to the then displayed interface information.

As discussed above, at least two keys 508 and 510 can include at least two different types of input sensors that are depicted by circuit elements 120 and 122 in communication with a processor 124 (see FIG. 1). The arrow 542 is intended to depict that touch across two keys is in the direction of the scrolling motion 540 of the initial information 506. It is understood that the number of keys touched is needs only to be two keys. Motion across two keys for example, key 508 and key 510 within a predetermined time provides a scrolling motion of the initial information 506.

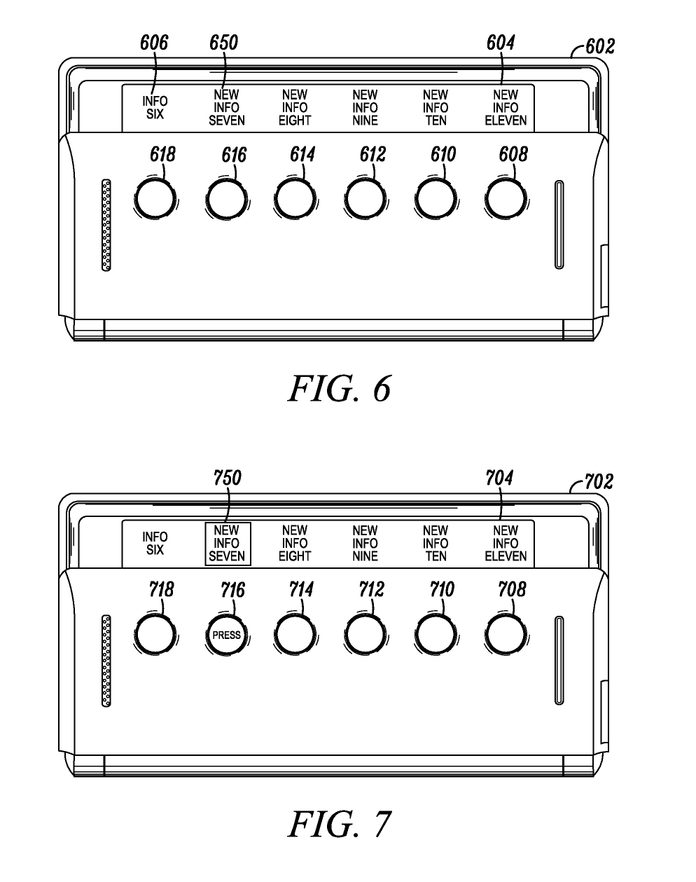

FIG. 6 depicts an embodiment of a device including new information displayed on the display screen 604. It is understood that the same or similar type of scrolling motion that was depicted for the initial information shown in FIGS. 2-4 is depicted between FIG. 5 and FIG. 6. The new information 650 “new info seven, new info eight, new info nine, new info ten” and “new info eleven” can be of the same form as that of the initial information 540 show in FIG. 5. Initial information 606 can be displayed along with the new information 650, as may any other type of information.

FIG. 7 depicts an embodiment of a device including displaying new information on the display so that one or more distinct portions of the new information is aligned one or more of the keys. Upon another touch type of touch signal a key, for example, a press, the information that is aligned with that key can further defined in such a manner that a user can drill down through layers of a user interface. In this way, a small display, such as a CLI display, can provide a substantial user interface.

Key 716 has indicated thereon, “press” which can be provided by a user. When the press has occurred, the information below the layer of “new info seven” can be further provided. “New info seven” can be highlighted in any suitable manner and the pressed key 716 can provide some type of annunciated that it has been pressed. For example, key 716 can be illuminated.

Different types of annunciation can be provided based upon what type of user input is received by a device. For example, when the device detects a swipe, backlights of the keys may illuminate in one particular color. When the device detects a press, backlights of the keys may illuminate in another particular color. In another example, in the event that sound is used, a swipe may sound like a harp and a press may sound like a bell.

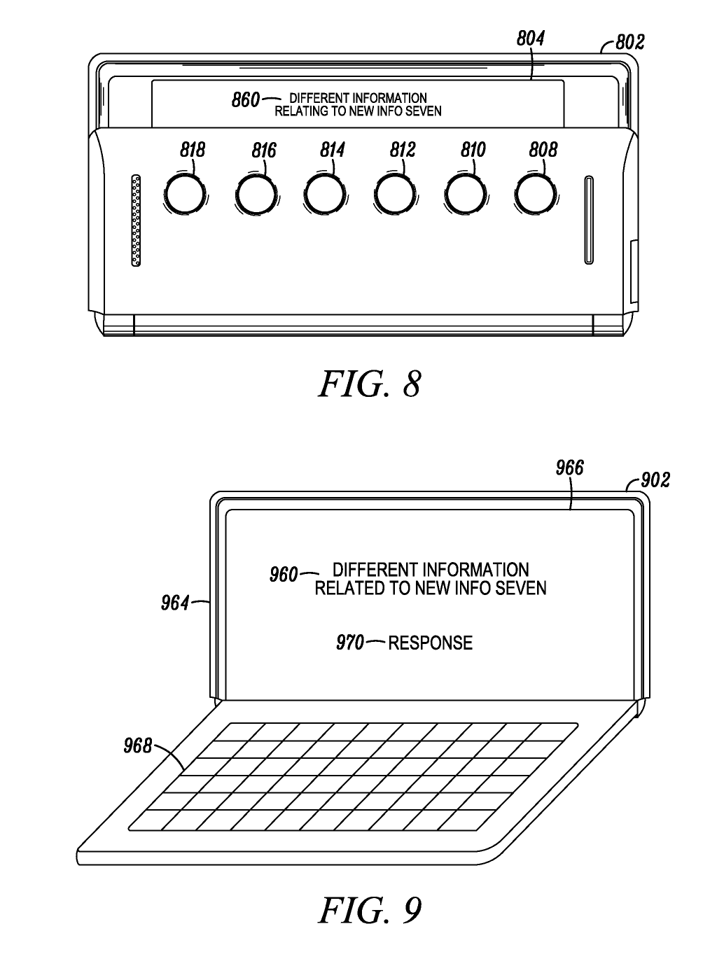

FIG. 8 depicts an embodiment of a device including displaying different information on the display wherein information below the layer of “new info seven” (see FIG. 7), “different information relating to new info seven” 860 is depicted. In this way, a small display, such as a CLI display, can provide a substantial user interface.

It is understood that either of these processes, swiping or pressing, can be repeated depending upon the manners in which the layers of the user interface are provided and the manners in which they were designed to be accessed. Scrolling of any type of information in response to swiping two or more keys can take place so new information is provide on the display. Another type of touch, for example a press on a key aligned with new information may drill down into another layer of the user interface. It is understood that any number of layers may be accessible in accordance with the operations of the disclosed devices and methods of user interfaces of devices. Of course, it is understood that a text response to “different information relating to new info seven” could be made in any suitable manner, such as by voice recognition and could be displayed on the small display screen 804. In such a case, a main display may need not be accessed.

FIG. 9 depicts an embodiment of an electronic device 902 that may be a mobile communication device such as that depicted throughout FIGS. 1-8, but in FIG. 9 depicted in an open position, revealing a main display of the device 902. The small display 804 (see FIG. 8) may be on the back side of the housing 964 that includes the main display 966. The “different information relating to new info seven” 860 of FIG. 8 may be displayed as text 960 on a main display 966 of the device 902. That is, the information shown on the small display 804 could be repeated on the main display 966. In one embodiment, were the “different information relating to new info seven” an instant messaging message, the user of the device 902, using keypad 968, could respond by keying in a response 970. For example, the keypad 968 could be a QWERTY keyboard, or any other type of keyboard that can be utilized to type messages, such as text messages.

As mentioned above, some keys of the keypad 968 may be utilized as soft keys depending upon the circumstances. For example, a main display screen 966 may provide soft key indicators, so that certain fixed keys, for example, on the keypad 968, can change their functionality based on the indication of the then displayed user interface, the keypad 968 as shown does not include the same functionality of the keys 808 and 810 which is described in detail above.

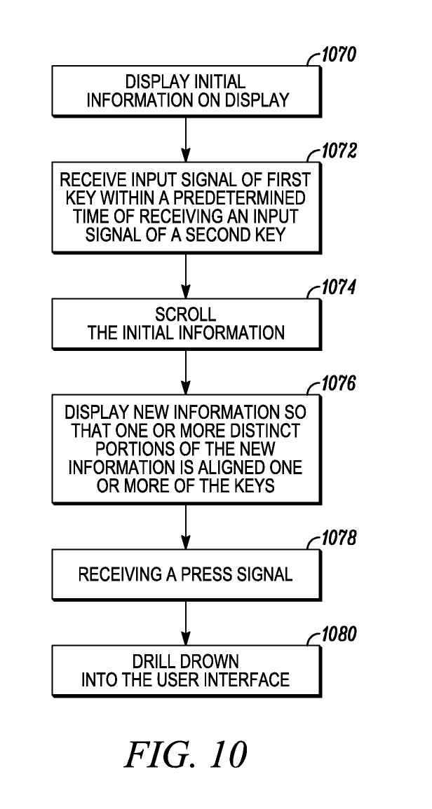

FIG. 10 is a flow chart illustrating an embodiment of the disclosed method. A device as depicted in the figures can include an information module 170 (see FIG. 1) configure to provide instructions for displaying initial information 1070 on the display. When a signal receiving module 172 receives 1072 an input signal of a first key within a predetermined time of receiving an input signal of a second key, as may be the case with a swiping gestural motion on at least two keys, the initial information is scrolled 1074. A scrolling module 174 can be configured to provide instructions for scrolling the information being displayed on the display when an input signal of a first key is received within a predetermined time to when an input signal of a second key is received. New information is displayed 1076 in accordance with a new information module 176 configured to provide instructions for displaying new information so that one or more distinct portions of the new information is aligned one or more the keys. The signal receiving module 172 can determine if a press is received 1078 by a key that is in alignment with such new information. It is understood that the process may repeat itself, so that the user may continue to drill down 1080 into the user interface as described above.

The disclosed devices and methods of a device's user interface provide the ability for a user to drill down through layers of a user interface to access information similar to that of the main display. Accordingly, there may be less of a power draw for accessing such information, and also the user may not need to access the main display when the same type of information may be displayed on a smaller display. In this way, a small display, such as a CLI display, can provide a substantial user interface.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method of a user interface of a device having keys configured for tactile awareness and configured to receive input signals and having a display, comprising:
displaying initial information on the display;
scrolling the initial information being displayed on the display when receiving an input signal of a first key within a predetermined time of receiving an input signal of a second key; and
displaying new information on the display so that one or more distinct portions of the new information is aligned one or more of the keys.

2. The method of claim 1, wherein displaying one or more distinct portions of the information comprises:
displaying categories of information.

3. The method of claim 1, wherein displaying initial information on the display so that one or more distinct portions of the information is aligned one or more the keys provides soft key functionality.

4. The method of claim 1, wherein receiving an input signal of a first key within a predetermined time of receiving an input signal of a second key comprises:
receiving a touch signal.

5. The method of claim 1, further comprising:
receiving an input signal to a single key that is a press signal.

6. The method of claim 1, further comprising:
annunciating that a key has received an input signal.

7. A device including user interface comprising:
at least two keys configured for tactile awareness and configured to receive input signals;
a display configured to display initial information; and
a processor to determine when an input signal is received of a first key within a predetermined time of receiving an input signal of a second key and in response, to scroll the initial information and to display new information so that one or more distinct portions of the new information is aligned one or more the keys and to determine when an input signal is received by a single key and in response to display new information on the display.

8. The device of claim 7, wherein the new information is based on a distinct portion of the initial information.

9. The device of claim 7, wherein the one or more distinct portions of the information are categories of information.

10. The device of claim 7, wherein each key comprises at least two different types of input sensors.

11. The device of claim 7, wherein each key comprises at least two of capacitive, resistive, infrared or mechanical sensors.

12. The device of claim 7, wherein each key is configured to receive a touch signal and a press signal.

13. The device of claim 7, further comprising:
an annunciation device to indicate that a key has received an input signal.

14. The device of claim 13, wherein the annunciation device is an audio device.

15. The device of claim 13, wherein the annunciation device is an illumination device.

16. A device user interface having keys configured for tactile awareness and configured to receive an input signal and having a display, comprising:
an information module configure to provide instructions for displaying information on the display;
a scrolling module configured to provide instructions for scrolling the information being displayed on the display when an input signal of a first key is received within a predetermined time to when an input signal of a second key is received; and
a new information module configured to provide instructions for displaying new information so that one or more distinct portions of the new information is aligned one or more the keys.

17. The device of claim 16, wherein the new information is based on a distinct portion of the initial information.

18. The device of claim 16, wherein each key comprises at least two different types of input sensors.

19. The device of claim 16, wherein the keys are concave.
